(19) United States
(12) Patent Application Publication
(10) Pub. No.: US 2002/0138310 A1
(43) Pub. Date: Sep. 26, 2002

(54) Process for online sale of an internet insurance product

(76) Inventor: Ty Sagalow, Syosset, NY (US)

Correspondence Address: PROSKAUER ROSE, 1585 BROADWAY, NEW YORK, NY, 100368299

(21) Appl. No.: 10/040,257

(22) Filed: Oct. 26, 2001

Related U.S. Application Data
(60) Provisional application No. 60/233,503, filed on Sep. 19, 2000.

(51) Int. Cl. G06F 17/60

(52) U.S. Cl. 705/4

(57) ABSTRACT

A method for selling an internet insurance product online includes an online application form with a menu of available insurance coverages. A user selects the coverages he wants, and completes the online application. The insurance underwriter performs a risk analysis, based on the user's online self-assessment, or on the underwriter's own security assessment. If the user is approved, an online quote is generated, and offered to the user. The user can then either accept or reject the quote online.

### RELATED APPLICATION

A Provisional Patent Application No. 60/233,503, entitled “Internet Insurance Product” was filed on Sep. 19, 2000, and is incorporated herein by reference. The subject matter of Provisional Patent Application No. 60/233,503 is related to the subject matter of the present invention, and is commonly assigned to the same assignee as is this application.

### BACKGROUND OF THE INVENTION

The present invention relates to an internet insurance product. More specifically, the present invention relates to a process for the online sale of an internet insurance product.

The internet insurance product disclosed in the above referenced Provisional Patent Application is designated therein as “AIGnetAdvantage^{SM} Suite”, and is comprised of 5 insurance policies, as described below:

AIGnetAdvantage^{SM}—for companies that use the Internet for advertising and marketing activities;

AIGnetAdvantage Professional^{SM}—for companies rendering professional services via the web, or serving e-clients;

AIGnetAdvantage Liability^{SM}—an extensive third-party Internet liability coverage for any company using the Internet;

AIGnetAdvantage Security^{SM}—robust protection for web content and network security risks for any company using the Internet; and

AIGnetAdvantage Complete^{SM}—total protection for web content, professional services and network security for any company using the Internet.

In order to sell this type of product on the internet, there must be an online application available for prospective customers. This application must be configured so that the customer can select only those insurance coverages he needs from the total suite of products offered.

While the application process is initiated online, the underwriting (risk analysis) can take place off-line or online, depending on the specific situation.

Furthermore, some types of insurance coverage require an onsite security assessment of the customer, which is conducted by an outside consulting agency. If a security assessment is deemed necessary by the underwriter, he will so advise the customer, and will introduce the customer to the appropriate security consulting agency. Typically, customers requesting some form of network security coverage (e.g., AIGnetAdvantage Liability^{SM}, AIGnetAdvantage Security^{SM}, or AIGnetAdvantage Complete^{SM}), and limits of liability in excess of a certain dollar amount (e.g., $3,000,000), will require an onsite security assessment. Moreover, the underwriter will also base a decision regarding onsite assessment upon additional criteria, such as complexity of the applicant's network architecture, operations of the applicant, and so forth.

For those customers requesting network security insurance coverage and lower dollar limits, an online self-assessment rating engine can be supplied. Upon answering a number of questions (based largely upon British Standard 7799), the applicant will receive a grade representing his security protocols against best practices. The result of this self-assessment will be utilized by the underwriter to complete the underwriting process.

Upon completion of the underwriter's analysis, an indication of coverage will be forwarded electronically to the applicant.

Additional functionality of the online process can include access to specimen policies and marketing materials. Moreover, the user can also have access to a status report of submission activity, as well as to a 24/7 customer call center.

Another development for the online sale of insurance products can include a fully automated underwriting process, which integrates a premium rating engine with the online security assessment, where applicable. In addition, indicators and binders can be available for procurement online.

Accordingly, it is an object of the present invention to define a method for the online sale of internet insurance products, such as AIGnetAdvantage^{SM} Suite, which includes all of the above described functionality.

### SUMMARY OF THE INVENTION

In accordance with an illustrative embodiment of the present invention, a method for selling an internet insurance product online comprises the steps of:

a. offering an online application to a user, where the online application includes a menu of available internet insurance coverages,

b. upon the user completing the online application, offering an online self-assessment rating engine to the user,

c. upon the user completing an online self-assessment, offering an online quote request form to the user,

d. upon the user completing the online quote request form for a particular set of internet insurance coverages, performing a risk analysis on the user,

e. upon satisfactorily completing the risk analysis, offering an online quote for the desired set of internet insurance coverages to the user,

f. upon the user accepting the online quote, completing the sale of the quoted set of internet insurance coverages to the user.

The user risk analysis is performed by the insurance underwriter, either off-line or online.

In the event the user requests a quote without completing an online self-assessment, the underwriter can require an onsite security assessment of the user, to determine whether or not to approve the user for an online quote.

Other online features of the inventive method enable the user to have access to specimen policies, status information regarding his quote request, and to a customer call center.

### BRIEF DESCRIPTION OF THE DRAWINGS

The invention is described in greater detail below through the example of embodiments shown in the drawings, wherein:

FIG. 1 depicts a flow diagram of an insurance product sales process, in accordance with one embodiment of the invention; and

FIG. 2 depicts a flow diagram of an insurance product sales process, in accordance with another embodiment of the invention.

### DETAILED DESCRIPTION OF PREFERRED EMBODIMENTS OF THE INVENTION

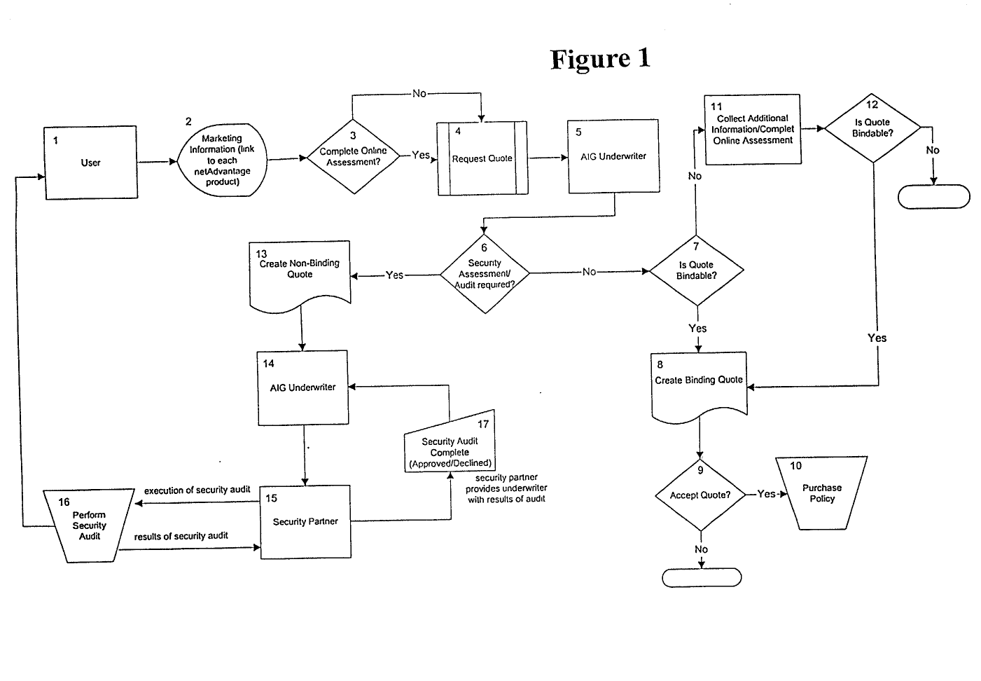

A first embodiment of the present invention is represented by the flow diagram in FIG. 1. In this embodiment, the sale of an internet insurance product takes place online, while the underwriting risk analysis is performed off-line.

In step 1 (FIG. 1), a prospective customer/user submits a request for insurance coverage by means of an online application, in which the various types of online insurance products are described (step 2).

Depending on the type of insurance product requested by the user, as well as the amount of applicable liability, the user may be subject to an onsite security assessment, or he may be able to utilize an online self-assessment rating engine (step 3).

If the user completes an online self-assessment, he can then request an online quote (step 4), which is reviewed by the insurance underwriter (steps 5 and 6). Assuming the self-assessment is satisfactory, the underwriter then determines whether or not a quote can be prepared for submission to the user (step 7).

If the underwriter is satisfied with the user's application and self-assessment, an online quote is created (step 8), and submitted to the user.

The user can then accept the quote (step 9) and purchase the policy (step 10).

Referring again to step 7, if more user information is needed to satisfy the underwriter's requirements, it is collected online and the assessment is completed (step 11).

If all conditions are satisfactory to the underwriter (step 12), a quote is created (step 8), and the process continues as previously described.

Referring back to steps 3-6, if the underwriter determines that an onsite security assessment is required, he can create a non-binding quote (step 13), and proceed with the services of an outside security agency (step 15).

The security agency performs the onsite security audit (step 16), and reports back to the underwriter (step 17).

If the audit is approved, the underwriter can then issue the quote in the manner previously described. If the audit is not approved, the quote will not be issued.

Additional functionality of the inventive embodiment includes access to specimen policies and marketing materials. Moreover, the user will have access to status reports of submission activity, and a 24/7 customer call center.

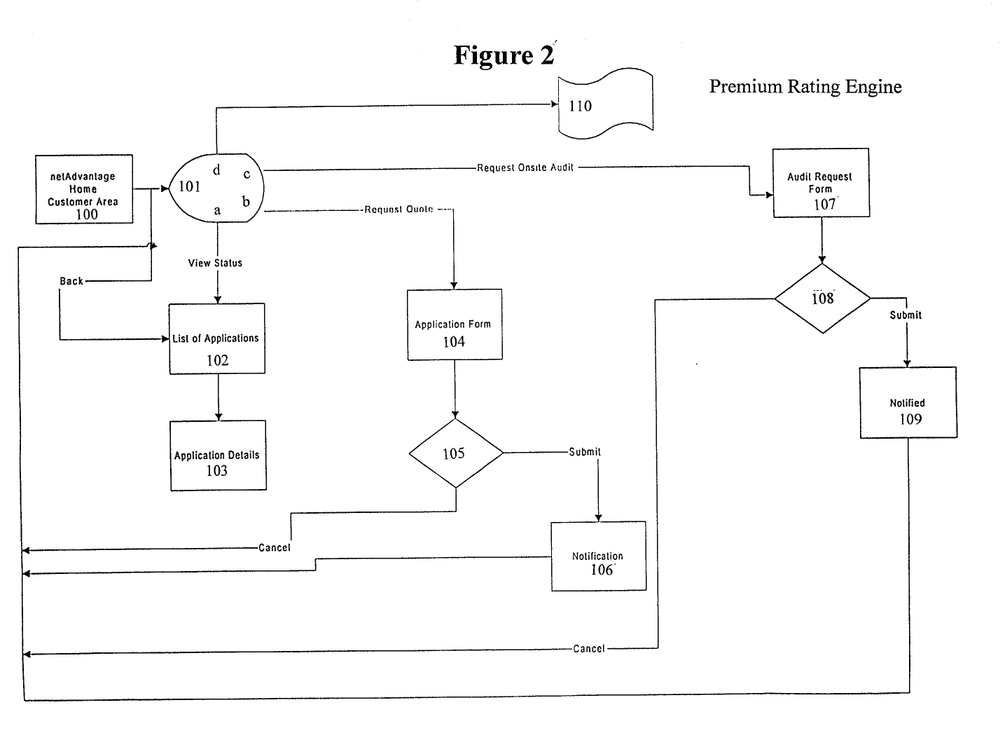

A second embodiment of the present invention is depicted in website form in the flow diagram shown in FIG. 2. In this embodiment, the underwriting process is online and fully automated, including a premium rating engine integrated with an online security assessment, as applicable.

In FIG. 2, box 100 represents the website home page, providing the prospective customer with various choices (101a, 101b, 101c, 101d). For example, the customer can select 101a to view a list of insurance product applications (102), as well as the application details (103).

The customer can also request a quote (101b) by means of an application form (104).

The customer can then submit the application (105), and await notification of acceptance (106).

Referring again to box 101, the customer can also request an onsite audit (101c) by means of an audit request form (107). He can then submit the audit request (108), and await notification (109), or he can cancel the request.

Where applicable, the customer can select 101d to make use of anonline rating engine (110), such as IBM Global Integrity™.

In other embodiments of the inventive method, the customer can also procure indications and binders online.

In short, an online process for the sale of an internet insurance product is disclosed, which includes product selection, underwriting risk analysis, and quote creation. Moreover, the disclosed method can include a completely automated, online underwriting process.

While the invention has been described by reference to specific embodiments, this was for purposes of illustration only and should not be construed to limit the scope of the invention. Numerous alternative embodiments will be apparent to those skilled in the art.

1. A method for selling an internet insurance product online to a user, comprising the steps of:
a. offering an online application to said user, said online application having a menu of available internet insurance coverages,
b. upon said user completing said online application, offering an online self-assessment rating engine to said user,
c. upon said user completing an online self-assessment, offering an online quote request form to said user,
d. upon said user completing said online quote request form for a particular set of internet insurance coverages, performing a risk analysis on said user,
e. upon satisfactorily completing said risk analysis, offering an online quote for said particular set of internet insurance coverages to said user,
f. upon said user accepting said online quote, selling said particular set of internet insurance coverages to said user.

2. The method of claim 1 wherein said risk analysis is performed off-line.

3. The method of claim 1 wherein said risk analysis is performed online.

4. The method of claim 1 wherein said user requests a quote without completing an online self-assessment.

5. The method of claim 1 wherein said risk analysis includes an onsite security assessment of said user.

6. The method of claim 5 wherein said onsite security assessment determines whether or not the user is approved for said online quote.

7. The method of claim 1 wherein said user has access to specimen policies.

8. The method of claim 1 wherein said user has access to status information regarding his quote request.

9. The method of claim 1 wherein said user has access to a call center.
